(19) United States
(12) Patent Application Publication
(10) Pub. No.: US 2004/0120487 A1
(43) Pub. Date: Jun. 24, 2004

(54) System and method for using third party billing of point of sale transactions

(75) Inventors: Elizabeth Anne Cockrell, San Antonio, TX (US); David Shawn Dobbins, San Antonio, TX (US); Edward Camacho Manibusan, San Antonio, TX (US); Michael Webster Simpson, San Antonio, TX (US); Craig Alan Needels, San Antonio, TX (US)

Correspondence Address: HAYNES AND BOONE, LLP, 901 MAIN STREET, SUITE 3100, DALLAS, TX, 75202, US

(73) Assignee: Billing Concepts, Inc., San Antonio, TX

(21) Appl. No.: 10/407,336

(22) Filed: Apr. 4, 2003

Related U.S. Application Data
(60) Provisional application No. 60/369,892, filed on Apr. 4, 2002.
(60) Provisional application No. 60/419,378, filed on Oct. 18, 2002.

(51) Int. Cl. H04M 15/00

(52) U.S. Cl. 379/114.01; 379/114.14

(57) ABSTRACT

Disclosed is a system and method for using third party billing of point of sale transactions. Transaction information is received from a merchant, and the transaction information comprises a telephone number. The system determines if an account associated with the telephone number is activated. If the account is activated, the transaction information is formatted and transmitted to a telephone company for placement on a telephone bill. If the account is not activated, an account is established and activated by capturing the ANI of a telephone call and verifying the ANI against the provided telephone number.

### RELATED PROVISIONAL PATENT APPLICATION

This application claims priority to U.S. Provisional Patent Application Serial No. 60/369,892, filed Apr. 4, 2002, entitled System and Method for Using Third Party Billing of Point of Sale Transactions, the entirety of which is hereby incorporated by reference. This application claims priority to U.S. Provisional Patent Application,Serial No. 60/419,378, filed Oct. 18, 2002, entitled System and Method for Using Third Party Billing of Transactions, the entirety of which is hereby incorporated by reference.

### SUMMARY OF INVENTION

The present invention provides a new and unique system and method for validating and billing transactions. The disclosed embodiments of the present invention provide for a method for receiving information from a merchant regarding a transaction initiated by a customer, such information comprising the customer's telephone number and transaction information, determining whether the customer's telephone number matches a telephone number in a user account, and transmitting transaction validation data to the merchant, when the customer's telephone number matches the telephone number in the user account.

The system also describes a communication module for receiving account information comprising a first telephone number and first identification number and transaction information comprising a second telephone number and a second identification number, an activation module in communication with the communication module for validating the first telephone number, establishing an account based on the first telephone number, and activating the account by receiving a telephone call and comparing the ANI of the telephone call against the first telephone number, a validation module in communication with the communication module and the activation module for analyzing the transaction information and for determining whether the first telephone number matches the second telephone number and whether the first identification number matches the second identification number, and a billing module in communication with the communication module for sending the transaction information to a billing entity.

### BRIEF DESCRIPTION OF THE DRAWINGS

FIG. 1 is an illustration of an embodiment of the invention.

FIG. 2 is an illustration of an embodiment of the invention.

FIG. 3 is an illustration of a computer for use with one embodiment of the invention.

FIG. 4 is a flowchart illustrating the establishment and activation of an account.

FIG. 5 is a flowchart illustrating the validation of a telephone number.

FIG. 6 is a flowchart illustrating the activation of an account.

FIG. 7 is a flowchart illustrating the operation of an embodiment of the invention.

FIG. 8 is a flowchart illustrating the submitting of a transaction to a billing entity.

### DESCRIPTION

The following disclosure provides many different embodiments, or examples, for implementing different features of a system and method for using third party billing of point of sale transactions. Specific examples of components, processes, and implementations are described to help clarify the invention. These are, of course, merely examples and are not intended to limit the invention from that described in the claims.

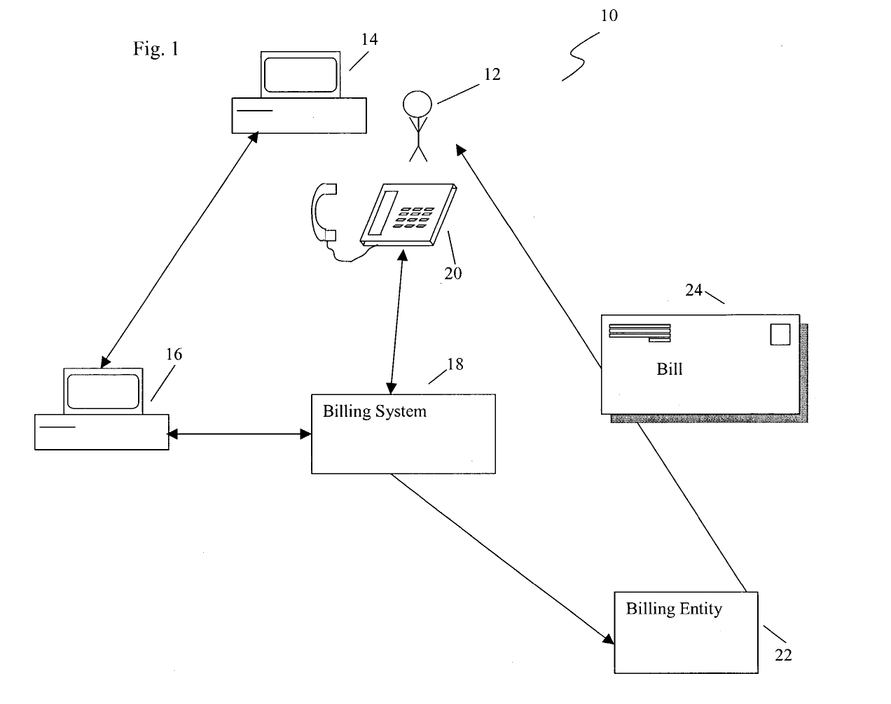

Referring to FIG. 1, one embodiment 10 of a system for using third party billing of point of sale transactions is shown. The embodiment 10 includes the billing system 18, which is in communication with a merchant system 16 and a billing entity 22. An individual 12 uses a node 14 to access merchant system 16, and uses a communication device 20 to access billing system 18. Billing entity 22 sends a bill 24 to user 12. Node 14 could be any form of internet-enabled device, such as a personal computer, cellphone, or personal digital assistant. In this embodiment, billing entity 22 is the telephone company providing telephone service to individual 12.

Merchant system 16 may be by any form of merchant, but could include those merchants with digital goods and services in the following areas: internet service providers, unified messaging services, voice over internet protocol (VoIP) services, news, sports, and entertainment websites, software and application service providers, and video clip and webcasting services. Additionally, while the present embodiment contemplates an online merchant, a standard retail merchant (e.g. a “brick-and-mortar” merchant) could also be used, as well as any other point of sale system. Further, while only one merchant system 16 is depicted, the billing system 18 may be used by individual 12 with multiple merchants. Conversely, each merchant system 16 could be connected to an individual billing system 18, with each merchant having individuals' accounts maintained separately from each other merchant's accounts. Moreover, while merchant system 16 and billing system 18 are indicated as separate, the present invention contemplates that merchant system 16 and billing system 18 could be combined.

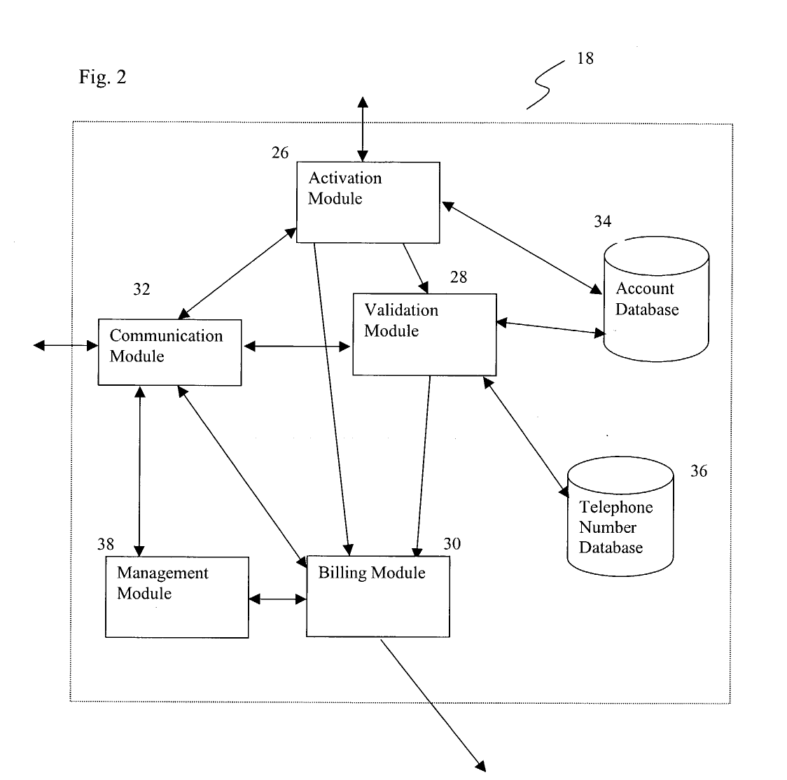

Referring to FIG. 2, one embodiment of billing system 18 is depicted. This embodiment comprises activation module 26 in communication with an validation module 28, a billing module 30, and account database 34. The validation module 28 is in communication with the telephone number database 36, billing module 30, and an account database 34. A management module 38 is in communication with the billing module 30. The activation module 26, validation module 28, billing module 38, and management module 30 are each in communication with communication module 32.

Account database 34 contains account information regarding the different individuals that have used the billing system 18 for transactions. The account information in the account database 34 may be sorted by the telephone number stored in each account. Telephone number database 36 contains information and data on telephone numbers, such as billing history and the local telephone company that handles the billing for each telephone number.

The activation module 26 provides the interface for the individual to activate an account with the billing system 18. In one embodiment, activation module 26 is an integrated voice response system. In this embodiment, the individual 12 (FIG. 1) uses the telephone device 20 (FIG. 1) to connect to the billing system 18 via activation module 26. The activation module 26 captures the automatic number identification (“ANI”) on the incoming call. The ANI number represents the telephone number of the telephone line used by the telephone device 20 (FIG. 1). Any form of telephone number could be used to contact billing system 18, including toll-free numbers or via 101XXXX numbers rather than 8XX numbers to prevent calls from college dormitories or other restricted phones.

The activation module 26 verifies that the ANI corresponds to a telephone number in an account in the account database 34. The activation module 26 may also prompt the individual for authorization statements and record the call for storage and later retrieval and playback. The activation module 26 may update the account database 34 to change the status of account, and may be available twenty-four hours a day, seven days a week.

The management module 38 allows merchant to view activity on the accounts and manage the accounts. This management module 38 may track consumer usage statistics and provide profiles of individuals who have purchased from merchant system 16 using the billing system 18. In this embodiment, the management module 38 could be internet-enabled, such that any node could access the module 38. The management module 38 could also allow individuals to access their respective accounts to monitor costs and account activity.

The validation module 28 handles whether a transaction submitted to the billing system 18 should be consummated and billed. When the merchant system 16 (FIG. 1) submits a transaction to the billing system 18 via the communication module 32, validation module 28 queries the telephone number database 36 or account database 34 to determine the billing history and status of the account associated with the telephone number provided by the individual when the transaction was initiated. Further, validation module 28 may have business rules, and such business rules, for example, could establish transaction limits based on dollar amount, dollar volume, number of transactions or other limits that may be desirable. Based on the information contained in databases 34, 36, as well as any applicable business rules, the validation module 28 returns validation scoring information to the merchant system 16 with respect to the transaction. The validation scoring information could be a score ranging from 0 to 100, with 0 being “Do Not Allow Transaction” and 100 being “Always Allow Transaction.” In other embodiments, the validation module 28 could return a simple boolean response of “Yes” or “No” with respect to the transaction. In addition to validating a transaction, the validation module 28 could respond to requests from merchants prior to the submission of a transaction to determine whether or not the individual needs to have an account established or activated.

In this current embodiment, the validation module 28 is reactive, or, in other words, responds to specific transaction submitted by the merchant. In other embodiments, however, the validation module 28 could be proactive and send notices to the merchant when certain criteria regarding an account are met, regardless of whether a transaction is pending, such as if a particular account has high incidences of fraud, the validation module 28 may send a notice to the merchant that the account should not be permitted to initiate transactions.

In any event, when the billing system 18 receives the transaction record at communication module 32, the transaction is handled by the billing module 30. The billing module 30 may then place the transaction into particular formats based on the requirements of the billing entity 22.

Referring back to FIG. 1, the merchant system 16 may have established its own threshold in order to permit a transaction. Based on the validation scoring information provided by the billing system 18, the merchant system 16 may: i) deny the transaction, ii) allow the transaction, or iii) defer the transaction while awaiting additional information or authorization. If the merchant system 16 denies the transaction, then the individual 12 may be informed and the transaction may not occur. In addition, the merchant system 16 could offer alternative payment methods to the individual 12, such as credit card payment. If the merchant system 16 allows the transaction, then the merchant system 16 may create a transaction record containing details regarding the transaction. The transaction record may be sent to the billing system 18.

If the merchant system 16 defers the transaction, the transaction may not be completed in real-time. Deferring may occur for many reasons, including that the individual 12 is not an authorized user of the billing system 18. If the individual 12 does not have an activated account with the billing system 18, the merchant may direct the individual to register with the billing system 18. In some instances the transaction may be held in a virtual shopping cart while awaiting activation of an account for the individual 12 with the billing system 18.

After the individual 12 is activates an account with the billing system 18, the individual 12 may return to the merchant system 16 and complete the transaction. In other instances, the billing system 18 would communicate with the merchant system 16 to inform the merchant system 16 that the individual 12 is now authorized and has an activated account, and the merchant system 16 could complete the transaction without further input from the individual 12.

The billing system 18 then submits the transaction record to the telephone company 22. Traditionally, bills from a telephone company 22 only contain charges incurred for telephone usage. The telephone company 22 may include the transaction between individual 12 and merchant system 16 on its bill 24, whether such bill is in paper or electronic form, and then send the bill 24 to individual 12. Upon receipt of the bill 24, the individual 12 may pay the telephone company 22, which may in turn pay the billing system 18. In some instances, the telephone company 22 may deduct a fee from the amounts paid to the billing system 18. The billing system 18 may pay the merchant system 16. In some instances, the billing system 18 may deduct a fee from the amounts paid to the merchant system 16. It is contemplated that the payments described herein may occur in any order.

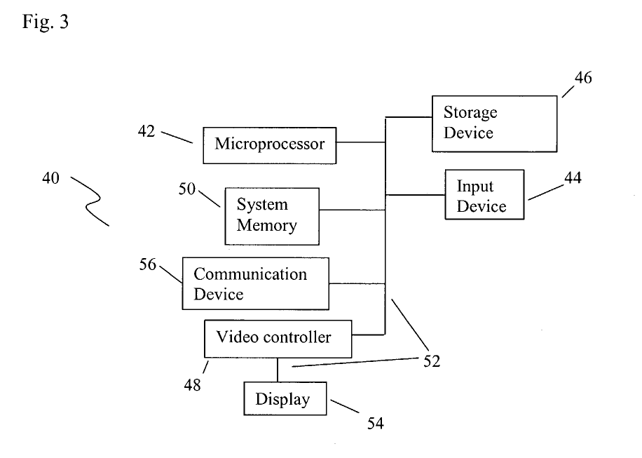

Referring to FIG. 3, an illustrative node 40 is depicted. Node 40 includes a microprocessor 42, an input device 44, a storage device 46, a video controller 48, a system memory 50, and a display 54, and a communication device 56 all interconnected by one or more buses 52. The storage device 46 could be a floppy drive, hard drive, CD-ROM, optical drive, or any other form of storage device. In addition, the storage device 42 may be capable of receiving a floppy disk, CD-ROM, DVD-ROM, or any other form of computer-readable medium that may contain computer-executable instructions. Further communication device 56 could be a modem, network card, or any other device to enable the node to communicate with other nodes. In certain embodiments, this node 40 could be used by merchant system 16 or billing system 18 to run the disclosed system and method.

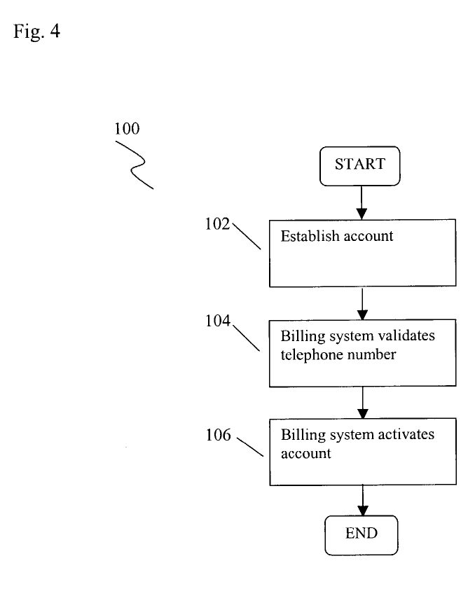

Referring now to FIG. 4, in one embodiment, a method 100 for establishing an account for use in third party billing of point of sale transactions system is shown. At step 102, an individual establishes an account with the billing entity. This step may involve obtaining the necessary information from the individual in order to bill the individual for goods or services purchased from a merchant, which may include the individual's name, telephone number, address, age, or other information. Obtaining this information may be done using an HTML form on the Internet, over the telephone, on paper (fill out form and mail or fax), using a client-side application in communication with the merchant or billing system, being in-person, or using other methods of obtaining information from an individual. In one embodiment, the individual contacts the merchant to establish an account, and the merchant may direct the consumer to a registration web page associated with the billing system. This direction of the consumer can be accomplished in a number of ways, such as loading the billing system web page in a new pop-up window, in a frame on the main window, or by simply providing a link from the merchant page. In another embodiment, the individual contacts the merchant and the merchant integrate its own registration web page and collects the necessary information. This collected information can then be submitted to the billing system by performing an HTTP “POST” or using other data transferring methods. In yet another embodiment, the individual could go directly to the billing system's registration web page.

At step 104, the billing system validates the telephone number provided when the account was established. Validation may be performed in many different ways. In one embodiment, validation may simply be a verification that the appropriate number of digits was provided for a telephone number.

At step 106, the billing system activates the account. As a precautionary measure, the billing system may be configured to require verification that the individual who established the account had the authority to do so.

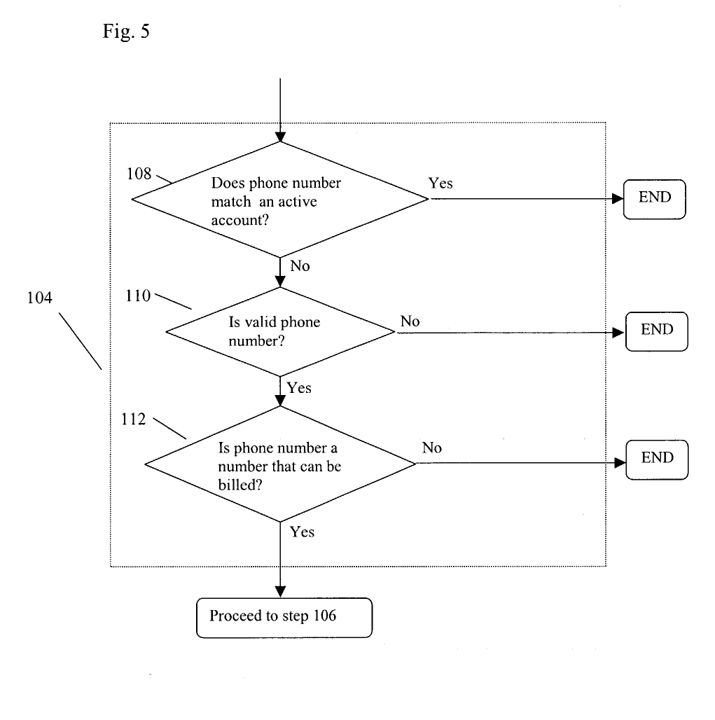

FIG. 5 refers to an embodiment for validating a telephone number that could be used as step 104 (FIG. 4). At step 108, the method determines whether the telephone number provided matches an existing account. If so, no further action needs to be taken, since an account already exists for that telephone number. If not, then at step 110, validation of the telephone number may be performed by querying databases of telephone numbers to determine if it is a telephone number recognized by the telephone companies. At step 112, further validation may be performed to determine if the local exchange carrier (“LEC”) permits third party billing of additional goods or services on the bills that the LEC provides to its customers. If the billing system is unable to validate the telephone number, the account is not established. If the billing system is able to validate the telephone number, then the method proceeds to step 106 (FIG. 4).

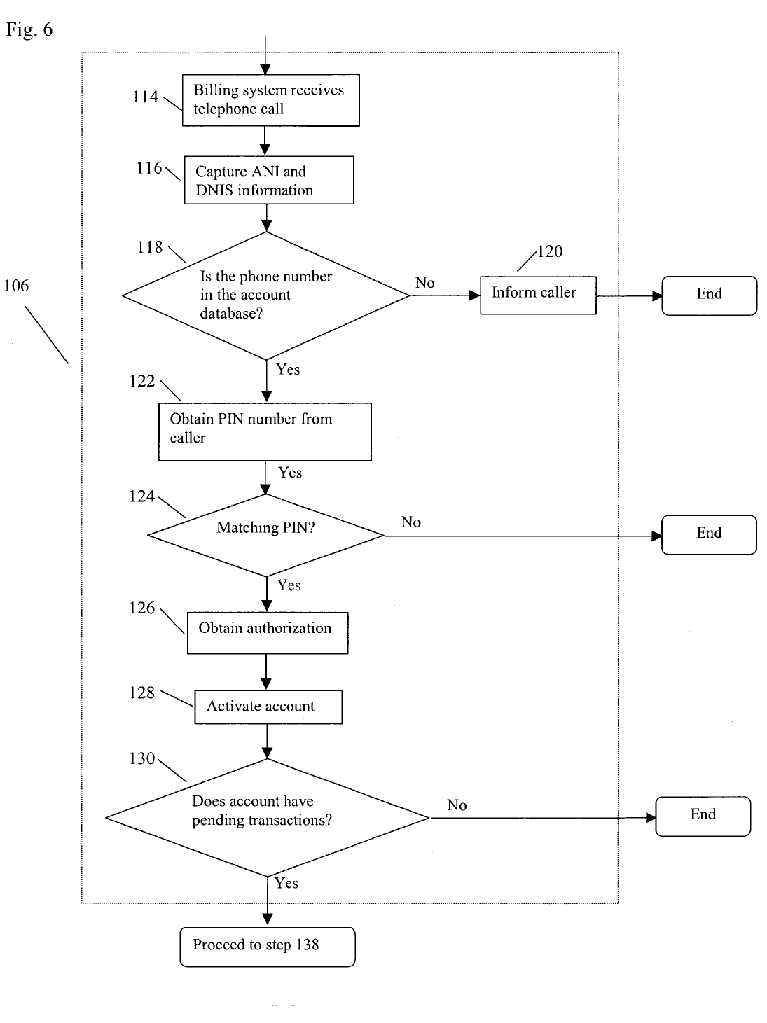

FIG. 6 illustrates an embodiment for activating an account that could be used as step 106 (FIG. 4). At step 114, the billing system receives a telephone call from an individual. At step 116, the billing system would capture the ANI number associated with the telephone line of the telephone call. In other embodiments, the billing system may also capture the dialed number identification service (“DNIS”) for the telephone call. At step 11 8, the billing system determines whether the ANT matches a telephone number in an established account. If not, the method would proceed to step 120, to inform the caller that there is no associated account. If so, the method may proceed to step 122.

At step 122, the billing system would obtain a personal identification number (“PIN”) from the individual. At step 124, the billing system would compare this PIN number against the PIN number provided in the correlating account. If the numbers do not match, the account would not be activated. If the numbers do match, the method may proceed to step 126.

At step 126, the billing system may query the caller about authorizing charges to be placed onto that caller's telephone bill and obtain verbal or DTMF responses. Voice recordings may be taken of the caller's responses and the voice recordings may be stored in any format, including .wav or .mp3.

At step 128, the account is activated, signifying that the billing system can now bill transactions to the account. At step 130, the billing system may determine whether any transactions had been initiated that are associated with the account. If there are no transactions, the method may end. If there are transactions, the method may proceed to step 138.

In other embodiments, the order and timing of these steps may be modified or re-arranged, and many steps could be excluded. Also, it will be understood by those skilled in the art that other steps could be taken to provide even greater levels of security and obtain additional amounts of authorization and verification from the caller.

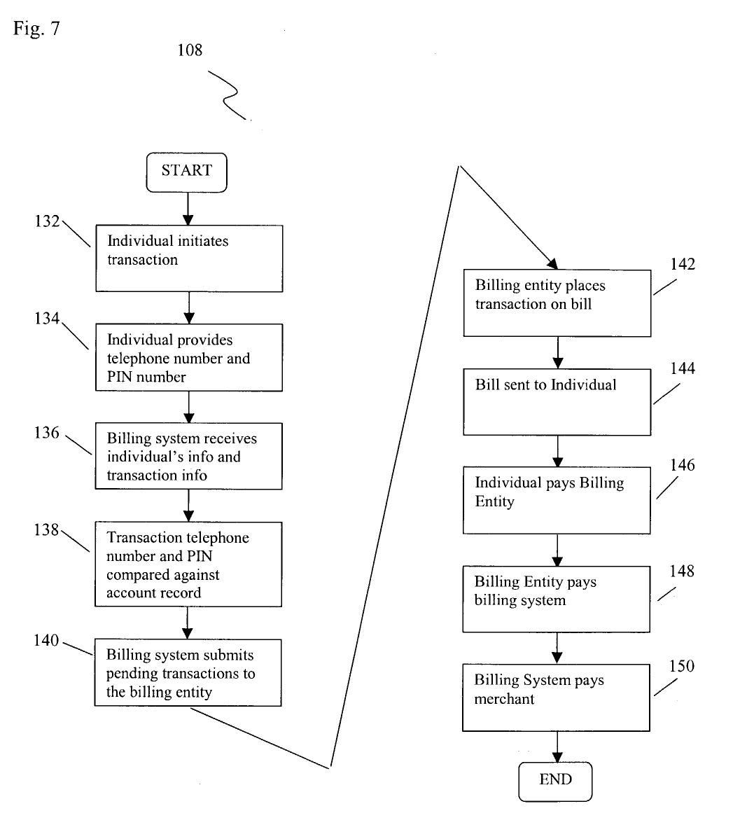

Referring now to FIG. 7, an embodiment of a method for using third party billing of point of sale transactions is shown, such as may be implemented by billing system 18 of FIG. 1. At step 132, an individual initiates a transaction with a merchant. While this embodiment uses a single transaction, the system and method could be used for recurring charges, as well. At step 134, as a payment option for the transaction, the individual provides a telephone number and identification number (such as a PIN), as well as other billing information that the merchant may require or desire, such as name and address.

At step 136, the billing system receives the billing information from the merchant, as well as the information regarding the transaction initiated by the merchant, which may include a product type and dollar amount. The billing system can receive the transaction information using any data transferring method. In one embodiment, the merchant can send transaction information for multiple transaction in a batch to the billing system. In this embodiment, the transactions are aggregated for some time period and submitted to the billing system.

At step 138, the billing system validates the telephone number to determine if the telephone number is associated with an activated account to which the transaction may be billed. If an account exists to which the transaction may be billed, the method proceeds to step 140. If no account exists or the account is not activated, the transaction may be terminated or placed on hold for an amount of time until the individual establishes and activates an account with the billing system.

At step 140, the transaction information is submitted to the billing entity that handles the billing for the individual. In this embodiment, the billing entity is the local telephone service provider for the individual, but other billing entities could be used, such as a mobile telephone service provider, cable or satellite television provider, or any other entity that bills individuals.

At step 142, the telephone service provider places the transaction onto the individual's telephone bill. At step 144, the telephone bill is sent to the individual. In general, this bill also contains the service charges for the other services, so as to provide a consolidated bill for the individual. The manner of send may be by regular postal mail, via email, or other means of billing as is understood in the art.

At step 146, the individual pays the telephone service provider. At step 148, the telephone service provider pays the billing system. At step 150, the billing system pays the merchant.

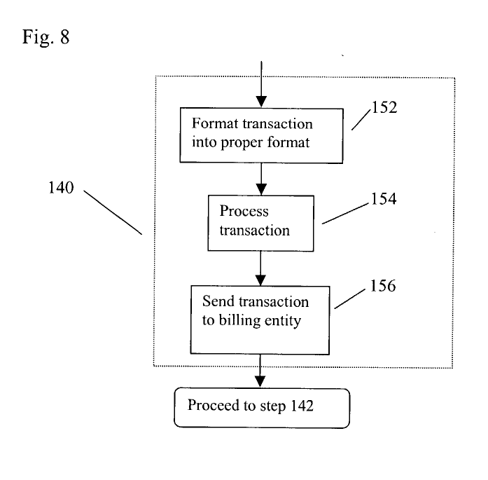

Referring to FIG. 8, is a further embodiment for submitting pending transactions to a billing entity. At step 152, the billing system formats the transaction into a billing format dictated by the telephone service provider. At step 154, the transaction may be processed according to the telephone service provider's requirements for accounting purposes. For example, the telephone service provider may require certain descriptions for each transaction for use on the consumer's bill. At step 156, the transaction is sent to the telephone service provider.

While the invention has been particularly shown and described with reference to the preferred embodiment thereof, it will be understood by those skilled in the art that various changes in form and detail may be made therein without departing from the spirit and scope of the invention.

I claim:

1. A method for billing, comprising:
receiving information from a merchant regarding a transaction initiated by a customer, such information comprising the customer's telephone number and transaction information;
determining whether the customer's telephone number matches a telephone number in a user account; and
transmitting transaction validation data to the merchant, when the customer's telephone number matches the telephone number in the user account.

2. The method of claim 1, wherein the receiving information comprises receiving a first identification number.

3. The method of claim 2, further comprising:
determining whether the first identification number matches a second identification number in a user account.

4. The method of claim 1, further comprising:
submitting the transaction information to a billing entity when the customer's telephone number matches the telephone number in the user account.

5. The method of claim 4, wherein submitting the transaction information comprises submitting the transaction information to a telephone company.

6. The method of claim 1, wherein transmitting transaction validation data to the merchant comprises transmitting data based on the customer's telephone bill payment history.

7. The method of claim 1, further comprising:
obtaining information, such information comprising a telephone number and a first identification number;
establishing a user account based on the telephone number, such account storing the first identification number;
receiving a telephone call;
capturing a telephone number from the telephone call;
obtaining a second identification number; and
verifying the captured telephone number against the obtained telephone number;
verifying the first identification number against the second identification number; and
activating the user account.

8. The method of claim 7, further comprising the step of:
obtaining authorization from the customer to place merchant transactions onto a bill from a billing entity.

9. A system for billing, comprising:
a communication module for receiving account information comprising a first telephone number and transaction information comprising a second telephone number;
an activation module in communication with the communication module for validating the first telephone number, establishing an account based on the first telephone number, and activating the account by receiving a telephone call and comparing the ANI of the telephone call against the first telephone number;
a validation module in communication with the communication module and the activation module for analyzing the transaction information and for determining whether the first telephone number matches the second telephone number; and
a billing module in communication with the communication module for sending the transaction information to a billing entity.

10. The system of claim 9, wherein the account information further comprises a first identification number and the transaction information further comprises a second identification number and wherein the validation module determines whether the first identification number matches the second identification number.

11. The system of claim 9, further comprising:
a management module in communication with the communication module for providing transaction information to a node.

12. The system of claim 9, further comprising:
a management module in communication with the communication module for providing account information to a node.

13. The system of claim 9, wherein the validation module analyzes the transaction information against business rules.

14. The system of claim 9, wherein the validation module monitors an account for fraud.

15. The system of claim 9, further comprising:
an account database in communication with the activation module.

16. The system of claim 9, further comprising:
a telephone number database in communication with the validation module.

17. A method for billing comprising:
receiving transaction information from a merchant, such transaction information comprising a telephone number;
determining if an account associated with the telephone number is activated;
if the account is activated, performing:
formatting the transaction information;
transmitting the transaction information to a telephone company for placement on a telephone bill for the telephone number;
if the account is not activated, performing:
validating the telephone number;
establishing the account based on the telephone number;
receiving a telephone call;
capturing the ANI of the telephone call;
verifying the ANI against the telephone number; and
activating the account.
